(19) United States
(12) Patent Application Publication
(10) Pub. No.: US 2012/0316682 A1
(43) Pub. Date: Dec. 13, 2012

(54) BALANCE CONTROL APPARATUS OF ROBOT AND CONTROL METHOD THEREOF

(75) Inventors: Kee Hong SEO, Seoul (KR); Joo Hyung Kim, Seongnam-si (KR); Kyung Shik Roh, Seongnam-si (KR)

(73) Assignee: Samsung Electronics Co., Ltd., Suwon-si (KR)

(21) Appl. No.: 13/369,438

(22) Filed: Feb. 9, 2012

(30) Foreign Application Priority Data
Jun. 10, 2011 (KR) 10-2011-0055954

(51) Int. Cl. B25J 13/08

(52) U.S. Cl. 700/261; 901/1; 901/9; 901/46

(57) ABSTRACT

A balance control apparatus of a robot and a control method thereof. The balance control method of the robot, which has a plurality of legs and an upper body, includes detecting pose angles of the upper body and angles of the plurality of joint units, acquiring a current capture point and a current hip height based on the pose angles and the angles of the plurality of joint units, calculating a capture point error by comparing the current capture point with a target capture point, calculating a hip height error by comparing the current hip height with a target hip height, calculating compensation forces based on the capture point error and the hip height error, calculating torques respectively applied to the plurality of joint units based on the compensation forces, and outputting the torques to the plurality of joint units to control balance of the robot.

### CROSS-REFERENCE TO RELATED APPLICATIONS

This application claims the benefit of Korean Patent Application No. 2011-0055954, filed on Jun. 10, 2011 in the Korean Intellectual Property Office, the disclosure of which is incorporated herein by reference.

### BACKGROUND

1. Field

Embodiments relate to a balance control apparatus of a robot which controls driving of joint units provided on a plurality of legs to keep the balance of the robot, and a control method thereof.

2. Description of the Related Art

In general, robots have a joint system similar to humans and perform motions similar to those of human hands and feet using such a joint system.

Industrial robots for automation and unmanned operation of production in factories were developed at the initial stage, and service robots to provide various services to humans have been vigorously developed now.

These service robots provide services to humans while performing walking similar to walking of humans. Therefore, development and research into robots walking while maintaining a stable pose have been actively progressing.

As methods to control waking of robots, there are a position-based Zero Moment Point (hereinafter, referred to as ZMP) control method, in which target positions of robot joints are tracked, and a torque-based dynamic walking control method and a Finite State Machine (hereinafter, referred to as FSM) control method, in which target torques of robot joints are tracked.

The position-based ZMP control method achieves precise position control, but requires precise angle control of respective joints of a robot and thus requires high servo gain. Thereby, the ZMP control method requires high current and thus has low energy efficiency and high stiffness of the joints and may apply high impact during collusion with surrounding environments.

Further, in order to calculate angles of the respective joints through inverse kinematics from a given center of gravity (COG) and walking patterns of legs, the ZMP control method needs to avoid kinematic singularities, thus causing the robot to bend knees at any time during walking and to have a unnatural gait differently from that of a human.

Further, when inverse kinematics is used, position control of joints is needed. Here, in order to perform a desired motion, high gain is used, thus causing the joints not to flexibly cope with a temporary disturbance.

The torque-based dynamic walking control method needs to solve a dynamic equation to achieve stable walking of a robot. However, if a robot having legs with 6 degrees of freedom moving in a random direction in a space is used, the dynamic equation becomes excessively complicated. Therefore, the dynamic equation has been actually applied to robots having legs with 4 degrees of freedom or less.

The FSM control method achieves control through torque commands and is applicable to an elastic mechanism and thus has high energy efficiency and low stiffness of joints, thereby being safe in surrounding environments. However, the FSM control method does not achieve precise position control and thus is not easy to perform a precise whole body motion, such as ascending a stairway or avoiding an obstacle.

### SUMMARY

Therefore, it is an aspect of an embodiment to provide a balance control apparatus of a robot which maintains a balanced upright pose by compensating for force in the horizontal direction and force in the vertical direction based on a capture point and a hip height, and a control method thereof.

It is another aspect of an embodiment to provide a balance control apparatus of a robot which maintains a balanced pose by compensating for moments based on pose angles, and a control method thereof.

It is a further aspect of an embodiment to provide a balance control apparatus of a robot which maintains a balanced pose by distributing compensation force applied to a plurality of legs, and a control method thereof.

Additional aspects of embodiments will be set forth in part in the description which follows and, in part, will be obvious from the description, or may be learned by practice of embodiments.

In accordance with one aspect of an embodiment, a balance control apparatus of a robot, has a plurality of legs, each having a plurality of joint units, and an upper body connected to the plurality of legs, includes detecting pose angles of the upper body and angles of the plurality of joint units, acquiring a current capture point and a current hip height based on the pose angles and the angles of the plurality of joint units, calculating a capture point error by comparing the current capture point with a predetermined target capture point, calculating a hip height error by comparing the current hip height with a predetermined target hip height, calculating compensation forces based on the capture point error and the hip height error, calculating torques respectively applied to the plurality of joint units based on the compensation forces, and outputting the torques to the plurality of joint units to control balance of the robot.

Acquisition of the current capture point may include acquiring a center of gravity (COG) of the robot based on the pose angles of the upper body and the angles of the plurality of joint units, acquiring a position and velocity of a point of the COG projected onto the ground surface, and acquiring the current capture point based on the position and velocity of the projected point of the COG.

Calculation of the current hip height may include calculating the current hip height based on the COG and the angles of the plurality of joint units.

Calculation of the compensation forces may include calculating compensation forces in the horizontal direction using the capture point error and calculating compensation force in the vertical direction using the hip height error.

The balance control method may further include judging a current pose based on the pose angles of the upper body and the angles of the plurality of joint units and setting the target capture point and the target hip height based on the current pose and motion data stored in advance.

Calculation of the torques may include calculating a distance ratio between a point of a COG of the robot projected onto the ground surface and feet connected to the plurality of legs, distributing the compensation forces applied to the plurality of legs based on the distance ratio between the projected point of the COG and the feet, and calculating the torques respectively applied to the plurality of joint units based on the compensation forces distributed to the plurality of legs.

In acquisition of the current capture point, forward kinematics may be used.

The balance control method may further include calculating pose angle errors by comparing the current pose angles of the upper body with predetermined target pose angles, calculating compensation moments based on the pose angle errors, and calculating torques respectively applied to the plurality of joint units based on the compensation moments.

Calculation of the compensation moments may include calculating compensation moments in the yaw, roll and pitch directions using the pose angle errors.

In accordance with another aspect of an embodiment, a balance control apparatus of a robot, which has a plurality of legs, each having a plurality of joint units, and an upper body connected to the plurality of legs, includes a pose detection unit to detect pose angles of the upper body, an angle detection unit to detect angles of the plurality of joint units, a setup unit to set a target capture point and a target hip height based on motion data stored in advance, a balance controller to acquire a current capture point and a current hip height based on the pose angles and the angles of the plurality of joint units, to calculate a capture point error by comparing the current capture point with the target capture point, to calculate a hip height error by comparing the current hip height with the target hip height, to calculate compensation forces based on the capture point error and the hip height error, and to calculate torques respectively applied to the plurality of joint units based on the compensation forces, and a servo controller to respectively output the torques to the plurality of joint units.

The balance controller may include an acquisition unit to acquire a center of gravity (COG) of the robot based on the pose angles of the upper body and the angles of the plurality of joint units and to acquire the current capture point and the hip height based on the COG.

The balance controller may calculate compensation forces in the horizontal direction using the capture point error and calculate compensation force in the vertical direction using the hip height error.

The balance control apparatus may further include a force/torque detection unit to detect loads respectively applied to feet provided on the plurality of legs, and the setup unit may judge a current pose based on the loads respectively applied to the feet and set the target capture point and the target hip height based on the current pose and the motion data stored in advance.

The balance control apparatus may further include a distribution unit to calculate a distance ratio between a point of a COG of the robot projected onto the ground surface and the feet connected to the plurality of legs and to distribute the compensation forces applied to the plurality of legs based on the distance ratio between the projected point of the COG and the feet, and the balance controller may calculate the torques respectively applied to the plurality of joint units based on the compensation forces distributed to the plurality of legs.

The balance controller may calculate pose angle errors by comparing the current pose angles of the upper body with predetermined target pose angles, calculate compensation moments based on the pose angle errors, and reflect the compensation moments in calculation of the torques.

The balance controller may calculate compensation moments in the yaw, roll and pitch directions using the pose angle errors.

The setup unit may set one point located within a support region of feet provided on the plurality of legs as the target capture point.

The balance control apparatus may further include an input unit to receive motion data including at least one pose from a user, and the setup unit may store the received motion data.

### BRIEF DESCRIPTION OF THE DRAWINGS

These and/or other aspects of embodiments will become apparent and more readily appreciated from the following description of the embodiments, taken in conjunction with the accompanying drawings of which:

FIG. 1 is a view exemplarily illustrating an external appearance of a robot in accordance with an embodiment;

FIG. 2 is a view exemplarily illustrating joint structures of the robot in accordance with an embodiment;

FIG. 3 is a block diagram of a balance control apparatus of the robot in accordance with an embodiment;

FIG. 4 is a view exemplarily illustrating states of an FSM stored in the robot in accordance with an embodiment;

FIG. 5 is a detailed block diagram of the balance control apparatus of the robot in accordance with an embodiment;

FIG. 6 is a view exemplarily illustrating acquisition of a COG, a capture point and a hip height of the robot in accordance with an embodiment; and

FIG. 7 is a flowchart illustrating a balance control method of the robot in accordance with an embodiment.

### DETAILED DESCRIPTION

Reference will now be made in detail to embodiments, examples of which are illustrated in the accompanying drawings, wherein like reference numerals refer to like elements throughout.

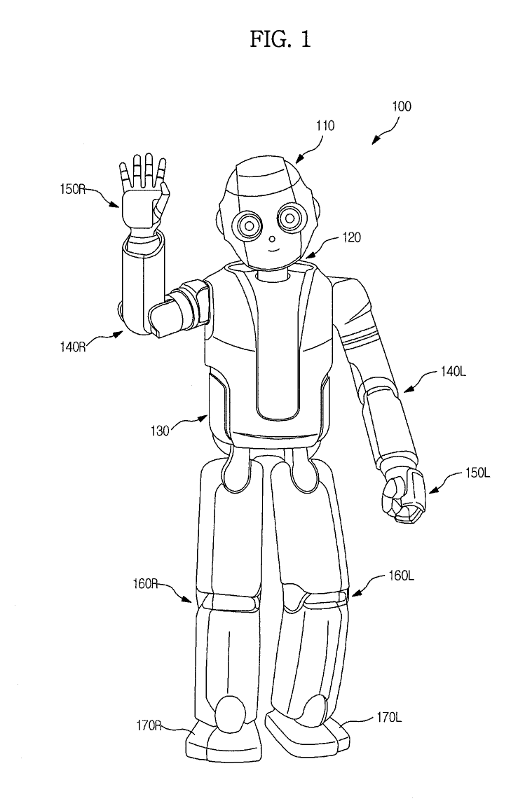

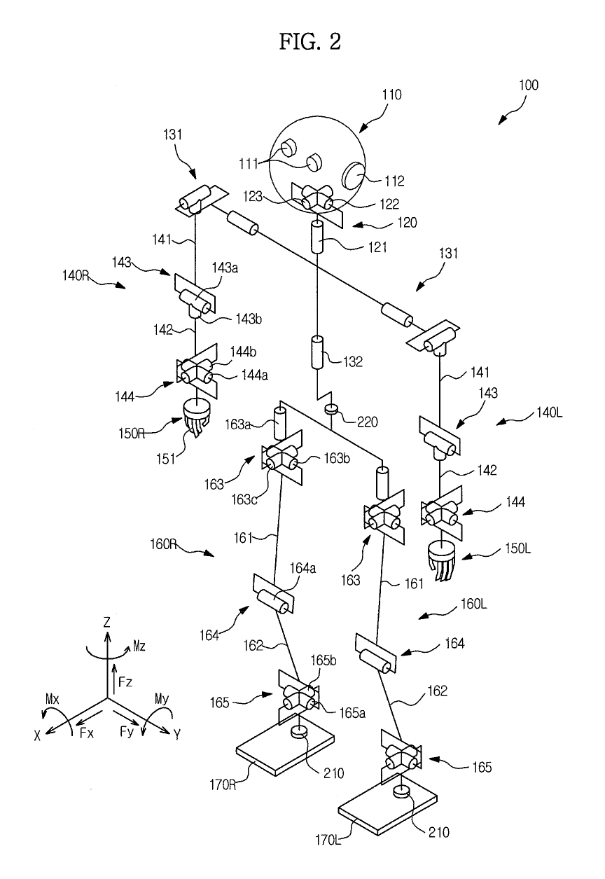

FIG. 1 is a view exemplarily illustrating an external appearance of a robot in accordance with an embodiment, and FIG. 2 is a view exemplarily illustrating joint structures of the robot in accordance with an embodiment.

As shown in FIG. 1, a robot 100 includes an upper body including a head 110, a neck 120, a torso 130, arms 140R and 140L and hands 150R and 150L, and a lower body including a plurality of legs 160R and 160L and feet 170R and 170L.

In more detail, the upper body of the robot 100 includes the head 110, the torso 130 connected to the lower portion of the head 110 through the neck 120, the two arms 140R and 140L connected to both sides of the upper portion of the torso 130, and the hands 1508 and 150L respectively connected to tips of the two arms 140R and 140L.

The lower body of the robot 100 includes the two legs 160R and 160L connected to both sides of the lower portion of the torso 130 of the upper body, and the feet 170R and 170L respectively connected to tips of the two legs 160R and 160L.

Here, the head 110, the two arms 140R and 140L, the two hands 150R and 150L, the two legs 160R and 160L and the two feet 170R and 170L respectively have designated degrees of freedom through joints.

The upper body and the lower body of the robot 100 are protected by covers.

Here, “R” and “L” respectively indicate the right and left sides of the robot 100.

Hereinafter, the joints of the robot 100 will be described in detail with reference to FIG. 2.

Cameras 111 to capture surrounding images and microphones 112 to detect user voice are installed on the head 110 of the robot 100.

The neck 120 connects the head 110 and the torso 130 to each other. The neck 120 includes a neck joint unit.

The neck joint unit includes a rotary joint 121 in the yaw direction (rotated around the z-axis), a rotary joint 122 in the pitch direction (rotated around the y-axis), and a rotary joint 123 in the roll direction (rotated around the x-axis), and thus has 3 degrees of freedom. The rotary joints 121, 122 and 123 of the neck joint unit are respectively connected to motors (not shown) to rotate the head 110.

Shoulder joint units 131 to connect the two arms 140R and 140L to the torso 130 are provided at both sides of the torso 130, and a rotary joint unit 132 in the yaw direction to rotate the breast relative to the waist is provided between the breast and the waist.

The two arms 140R and 140L respectively include upper arm links 141, lower arm links 142, elbow joint units 143 and wrist joint units 144.

The upper arm links 141 are connected to the torso 130 through the shoulder joint units 131, the upper arm links 141 and the lower arm links 142 are connected to each other through the elbow joint units 143, and the lower arm links 142 and the hands 150R and 150L are connected to each other by the wrist joint units 144.

Each elbow joint unit 143 includes a rotary joint 143a in the pitch direction and a rotary joint 143b in the yaw direction, and thus has 2 degrees of freedom. Each wrist joint unit 144 includes a rotary joint 144a in the pitch direction and a rotary joint 144b in the roll direction, and thus has 2 degrees of freedom.

Each hand 150R or 150L is provided with five fingers 151. A plurality of joints (not shown) driven by motors may be provided on the respective fingers 151. The fingers 151 perform various motions, such as gripping an article or pointing in a specific direction, in connection with movement of the arms 140R and 140L.

The two legs 160R and 160L of the robot 100 respectively include thigh links 161, calf links 162, hip joint units 163, knee joint units 164 and ankle joint units 165.

The thigh links 161 are connected to the torso 130 through the hip joint units 163, the thigh links 161 and the calf links 162 are connected to each other by the knee joint units 164, and the calf links 162 and the feet 170R and 170L are connected to each other by the ankle joint units 165.

Each hip joint unit 163 includes a rotary joint 163a in the yaw direction (rotated around the z-axis), a rotary joint 163b in the pitch direction (rotated around the y-axis), and a rotary joint 163c in the roll direction (rotated around the x-axis), and thus has 3 degrees of freedom.

Further, the position of the hip joint units 163 of the two legs 160R and 160L corresponds to the position of the hip.

Each knee joint unit 164 includes a rotary joint 164a in the pitch direction, and thus has 1 degree of freedom. Each ankle joint unit 165 includes a rotary joint 165a in the pitch direction and a rotary joint 165b in the roll direction, and thus has 2 degrees of freedom.

Since six rotary joints of the three joint units 163, 164 and 165 are provided on each of the two legs 160R and 160L, a total of twelve rotary joints is provided to the two legs 160R and 60L.

Actuators, such as motors (not shown), are provided on the respective joints of the robot 100. Thereby, the respective joints perform proper rotation through rotation of the motors, thus implementing various motions.

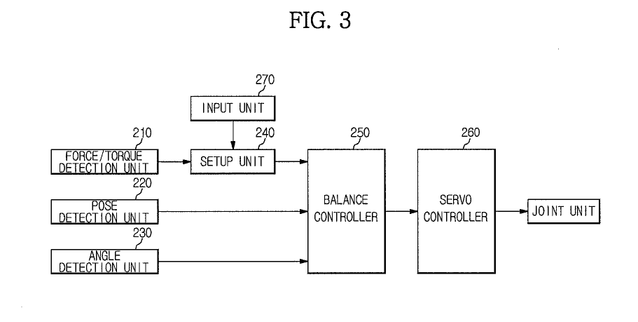

Thereby, when the robot 100 walks, the robot 100 may achieve stable and natural walking while keeping balance. This will be described in detail with reference to FIG. 3.

FIG. 3 is a block diagram of a balance control apparatus of the robot in accordance with an embodiment. Hereinafter, the balance control apparatus will be described with reference to FIGS. 3 to 6.

The balance control apparatus of the robot includes an force/torque detection unit 210, a pose detection unit 220, an angle detection unit 230, a setup unit 240, a COG acquisition unit 251a, a balance controller 250, a servo controller 260, and an input unit 270.

The force/torque detection unit 210 includes multi-axis force and torque (F/T) sensors provided between the legs 160R and 170L and the feet 170R and 170L, and detects load applied to the feet 170R and 170L.

Here, the force/torque detection unit 210 detects three-directional components Fx, Fy, and Fz of force and three-directional components Mx, My, and Mz of moment transmitted to the feet 170R and 170L and transmits these components to the setup unit 240.

The pose detection unit 220 is provided on the torso 130 and detects a pose of the upper body relative to the vertical line. The pose detection unit 220 detects rotating angles of three axes in the roll, pitch and yaw directions, and transmits the detected rotating angles of the respective axes to the COG acquisition unit 251a and the balance controller 250.

Here, the pose detection unit 220 may use an inertial measurement unit (IMU) to measure inertia.

Further, the in order to measure the pose of the upper body of the robot 100, instead of the IMU, a tilting detector or a gyro sensor may be used.

The angle detection unit 230 detects angles of the respective joint units 131, 143, 144, 163, 164 and 165, and particularly rotating angles of the motors provided at respective axes of the respective joint units 131, 143, 144, 163, 164 and 165.

Here, the rotating angles of the respective joint units 131, 143, 144, 163, 164 and 165 which are expressed as RPMs of the motors (not shown) may be detected by encoders (not shown) connected to the respective motors.

The setup unit 240 stores motion data transmitted from the input unit 270. Here, the motion data includes at least one pose to perform dancing or walking, and the at least one pose means the shape of the upper body and the lower body.

The setup unit 240 judges whether or not the respective feet touch the ground based on loads applied to the respective feet detected by the force/torque detection unit 210, and judges a leg to which load is applied to be in a support state and a leg to which load is not applied to be in a swing state.

The setup unit 240 judges a current pose based on the angles of the plural joint units, the pose angles of the upper body, ground-touching states of the feet, and positions of the feet, judges a next pose by comparing the current pose with the motion data, and sets a target capture point, target pose angles and a target hip height to perform the next pose.

During walking based on the FSM, the setup unit 240 may set the target capture point, the target pose angles and the target hip height based on whether or not the respective legs touch the ground and states of the FSM which are stored in advance.

Here, the capture point is a point of the COG which is projected onto the ground surface and represents x and y components, and the hip height represents a z component.

Further, the target pose angles may be set such that the upper body of the robot is parallel with the gravity direction to achieve the upright pose of the robot.

The target capture point is set to one point in a support polygon, i.e., a support region in which two feet of the robot are located so as to maintain the upright pose.

Hereinafter, state transition of the FSM of the robot 100 during walking of the robot 100 based on the FSM will be described.

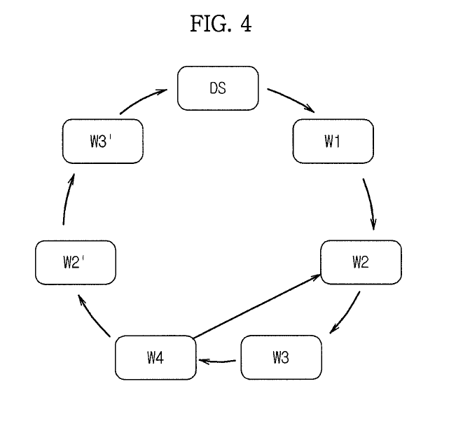

FIG. 4 is a view exemplarily illustrating transition of states of the two feet of the robot based on the FSM.

There are seven states of the two feet of the robot 100 based on the FSM. The states are circulated in order of the DS state→the W1 state→the W2 state→the W3 state→the W4 state→the W2 state→the W3 state→the W4 state→the W2 state→ . . . , or when a stoppage command is input, the W4 state transitions to the DS state via the W2′ state and the W3′ state corresponding a stoppage preparation motion.

It is understood that the target hip heights in the respective states of the FSM are the same, the x direction is a lengthwise direction of the support foot, the front of which represents the positive direction, and the y direction is a direction rotated from the x direction by 90 degrees in the counterclockwise direction as seen from the top.

Further, the support foot is the foot which touches the ground to maintain the pose of the robot, and the swing foot is the foot which is lifted upward to move the robot.

In the DS state, the two legs of the robot 100 touch the ground. The W1 state externally does not differ from the DS state, but in the W1 state, the COG of the robot 100 starts to move to one leg when the robot 100 starts walking.

Hereinafter, for example, the case in which the COG of the robot 100 moves to the left leg 160L will be described. In the W2 state, the robot 100 takes a standing pose in which the left leg 160L supported by the ground while the right leg 160R is lifted upward, and in the W3 state, the robot 100 takes a pose in which the right leg 160R is lowered and touches the ground while the robot 100 moves in the progressing direction.

In the W4 state, the robot 100 takes a pose in which the COG of the robot 100 moves to the left leg 160L after the right let 170R has touched the ground. Then, when the W4 state transitions again to the W2 state, the two legs are interchanged and circulation in order of the W2 state→the W3 state→the W4 state→the W2→ . . . is repeated until the stoppage command is input.

If the stoppage command is input, the W4 state transitions to the W2′ state. In the W2′ state, the left leg 160L is lifted upward similarly to the W2 state, but the x component of the target capture point is located at the center of the current support foot because the robot 100 does not move forward.

In the W3′ state, the left foot 170L touches the ground similarly to the W3 state, but the left foot 170L touches the ground at a position in parallel with the right foot 170R because the robot 100 does not move forward.

As described above, transition of the respective seven states of the FSM transitions is performed in designated order, and each state transitions to the next state when a designated transition requirement is satisfied.

Next, target capture points in the respective states of the FSM will be described.

First, the DS state is a state in which the two feet 170R and 170L of the robot 100 touch the ground and the robot 100 stops, and the target capture point in the DS state is located at the center of the support polygon formed by the two feet 170R and 170L of the robot 100. At this time, when a walking command is given, the DS state transitions to the W1 state.

The W1 state is a state in which the target capture point moves to the support foot randomly selected from the two feet 170R and 170L of the robot 100, and when an actual capture point enters a stable region within the width of the support foot, the W1 state transitions to the W2 state.

The W2 state is a state in which the robot 100 lifts the swing foot upward, and the x component of the target capture point in the W2 state is set to a trajectory moving from the center of the support foot to the front portion of the support foot according to time and the y component of the target capture point of the W2 state is set to be located at the central line of the support foot.

Further, lifting of the swing foot is controlled by gravity compensation. When the x component of the current capture point in the W2 state exceeds a threshold value and the height of the swing foot in the W2 state exceeds a threshold value, the W2 state transitions to the W3 state.

The W3 state represents a motion of lowering the swing foot while stretching the knee of the swing foot so as to touch the ground. In the W3 state, the x component of the target capture point is set to a trajectory increasing up to a position at which the swing foot will touch the ground over the front portion of the support foot according to time, and the y component of the target capture point is set to move to the position at which the swing foot will touch the ground according to time.

When the swing foot touches the ground and thus the force/torque detection unit 210 senses that the z component is more than a threshold value, the W3 state transitions to the W4 state.

The W4 state is a state in which the two feet of the robot 100 touch the ground under the condition that the foot finally touching the ground functions as the support foot. In the W4 state, the x and y components of the target capture point are set to trajectories continuously moving from the position of the target capture point in the former state to the center of the new support foot in a short time. When the current capture point enters the support foot, the W4 state transitions to the W2 state if the stoppage command is not given, and transitions to the W2′ state if the stoppage command is given.

The W2′ state represents a motion similar to the W2 state, i.e., a motion of lifting of the swing foot, but in the W2′ state, the x component of the target capture point is fixed to the center of the support foot because the robot 100 does not move forward but stops. When the height of the swing foot is more than the threshold value, the W2′ state transitions to W3′ state.

The W3′ state represents a motion similar to the W3 state, i.e., a motion of lowering the swing foot while stretching the knee of the swing foot so as to touch the ground, but in the W3′ state, the x component of the target capture point does not move to the front portion of the support foot but is located at the position of the support foot and the y component of the target capture point is set to move the other foot because the robot 100 does not move forward but stops. When the swing foot touches the ground and the z component detected by the force/torque detection unit 210 exceeds the threshold value, the W3′ state transitions to the DS state.

The balance controller 250 acquires the current capture point based on the center of gravity (COG), and calculates a capture point error by comparing the current capture point with the target capture point transmitted from the setup unit 240.

Further, the balance controller 250 calculates pose angle errors by comparing the current pose angles transmitted from the pose detection unit 220 with the target pose angles transmitted from the setup unit 240, and calculates torques using the pose angle errors and the capture point error.

Further, the balance controller 250 may calculate the current hip height based on the current pose angles transmitted from the pose detection unit 220 and the rotating angles of the respective joint units 131, 143, 144, 163, 164 and 165, calculate a hip height error by comparing the calculated current hip height with the target hip height, and calculate torques by reflecting the hip height error in the pose angle errors and the capture point error.

Here, forward kinematics may be used to calculate the position and velocity of the current COG, the capture point, the positions and directions of the two feet and the hip height.

The servo controller 260 controls torque servos of the respective joint units 163, 164 and 165 so as to reach the torques transmitted from the balance controller 250.

The servo controller 260 compares the torques of the respective joint units with the calculated torques and thus adjusts currents of the motors so that the torques of the respective joint units are close to the calculated torques. In more detail, in order to generate torques calculated by the balance controller 250, the servo controller 260 controls PWMs corresponding to the calculated torques and outputs the controlled PWMs to the motors (not shown) provided on the axes of the respective joint units 163, 164 and 165.

The input unit 270 receives motion data including at least one pose to perform dancing and walking from a user, and transmits the received data to the setup unit 240.

Here, the motion data includes a plurality of sequentially stored poses. That is, the robot 100 performs a motion, such as dancing or walking, by continuously performing the plurality of poses.

One pose includes position data of the links 141, 142, 161 and 162 provided on the torso, the arms and the legs of the robot 100 or angle data of the respective joint units 131, 143, 144, 163, 164 and 165 provided on the torso, the arms and the legs of the robot 100. That is, the torso, the arms and the legs of the robot 100 form a specific shape, thus taking one pose.

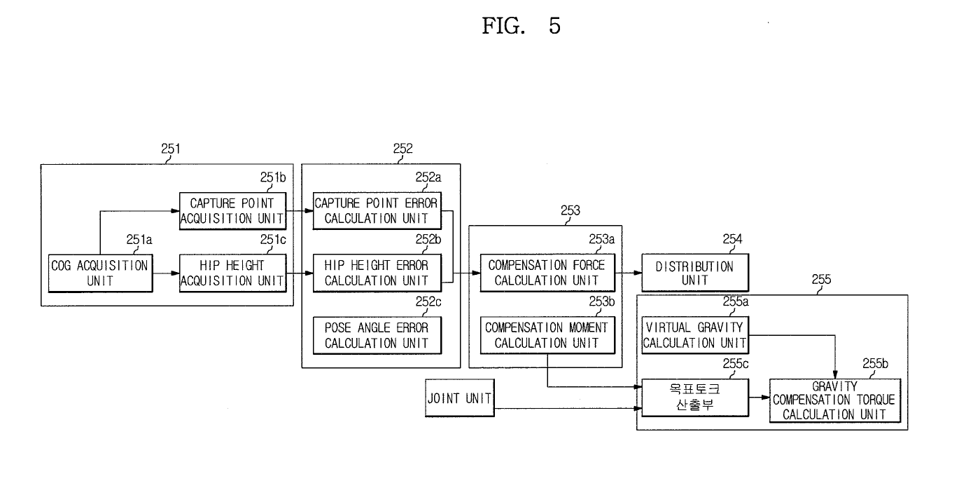

Hereinafter, the balance controller 250 will be described in more detail with reference to FIG. 5.

The balance controller 250 includes an acquisition unit 251, an error calculation unit 252, a compensation unit 253, a distribution unit 254 and a torque calculation unit 255.

The acquisition unit 251 includes a COG acquisition unit 251a to acquire the COG of the robot based on the pose angles of the upper body detected by the pose detection unit 220 and the rotating angles of the respective joint units 131, 143, 144, 163, 164 and 165 corresponding to the current pose of the robot, a capture point acquisition unit 251b to acquire the current capture point based on the COG transmitted from the COG acquisition unit 251a, and a hip height acquisition unit 251c to acquire the current hip height based on the COG transmitted from the COG acquisition unit 251a.

Here, the capture point has x-axis and y-axis coordinate values which are the coordinate values of horizontal components, and has a z-axis coordinate value which is the coordinate value of a vertical component.

That is, the acquisition unit 251 acquires the x-axis, y-axis and z-axis coordinate values based on the COG.

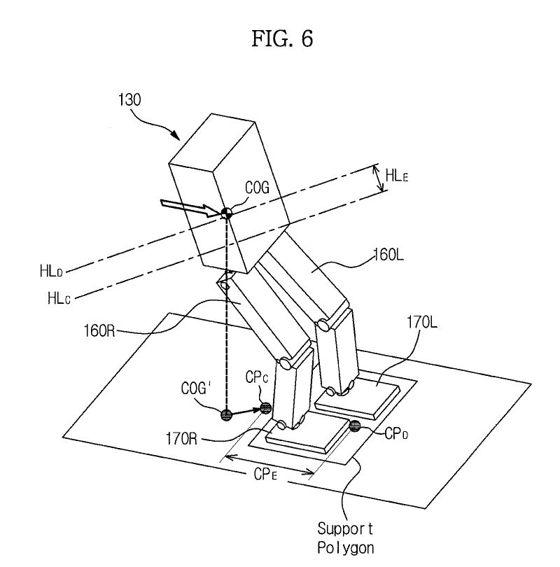

Now, acquisition of the current capture point will be described with reference to FIG. 6.

The acquisition unit 251 calculates the states of the two feet 170R and 170L of the robot 100 and the position and velocity of the COG, and calculates the current capture point CP_{C} of the robot 100 using the position and velocity of the COG.

In more detail, the acquisition unit 251 calculates the position and velocity of the COG, the hip height, and the positions and directions of the two feet 170R and 170L by applying the angles of the respective joint units 131, 143, 144, 163, 164 and 165, sizes and weights of the links 141, 142, 161 and 162 which are stored in advance, and the pose angles to forward kinematics.

Then, the acquisition unit 251 acquires the current capture point CP_{C} using the position and velocity of the COG.

The capture point CP is a position where the robot 100 may stand upright based on the position and velocity of the current COG of the robot 100 without falling when the robot 100 performs the next walking motion.

The capture point at the current position of the robot 100 may be acquired based on Equation 1 below.

CP=dCOG+w*vCOG Equation 1

Here, CP is a capture point, dCOG is the position of a point of the COG projected onto the ground surface, vCOG is the velocity of the projected point of the COG, and w is √(I/g) in which I is the height from the ground surface to the COG and g is acceleration of gravity.

The error calculation unit 252 includes a capture point error calculation unit 252a to calculate a capture point error CP_{E} by comparing the current capture point CP_{C} with the target capture point CP_{D} transmitted from the setup unit 240, a hip height error calculation unit 252b to calculate a hip height error HL_{E} by comparing the current hip height HL_{C} with the target hip height HL_{D} transmitted from the setup unit 240, and a pose angle error calculation unit 252c to calculate pose angle errors by comparing the current pose angles transmitted from the pose detection unit 220 with the target pose angles transmitted from the setup unit 240.

The compensation unit 253 calculates compensation forces and compensation moments to maintain the upright state of the robot 100.

The compensation unit 253 includes a compensation force calculation unit 253a to calculate the compensation forces based on the capture point error and the hip height error, and a compensation moment calculation unit 253b to calculate the compensation moments based on the pose angle errors.

That is, the compensation force calculation unit 253a calculates compensation forces in the x and y directions which are to be compensated for from the capture point error, and calculates compensation force in the z direction which is to be compensated for from the hip height error, and the compensation moment calculation unit 253b calculates compensation moments in the x, y and z directions which are to be compensated for from the pose angle errors.

That is, the compensation unit 253 calculates the compensation forces in the x, y and z directions and the compensation moments in the x, y and z directions which are to be compensated for to balance the robot 100, and thereby the robot 100 may maintain an upright pose.

The compensation force is calculated by Equation 1 below.

CP=dCOG+w*vCOG Equation 1

Since a set of coordinates of the horizontal components of the COG is (x, y) and the velocity of the COG is (x′, y′) obtained by differentiating the set of coordinates of the horizontal components, a relation expression of CP=(x, y)+w(x′, y′)=(x+wx′, y+wy′) is satisfied.

A position error (e) of triaxial coordinates in which the capture point and the hip height are reflected is calculated by Equation 2 below.

$$\begin{matrix}e = ( [ ( {x}^{*} , {y}^{*} ) - ( x + {wx}^{′} , y + {wy}^{′} ) ] , {z}^{*} - z ) \\ = ( {x}^{*} - ( x + {wx}^{′} ) , {y}^{*} - ( y + {wy}^{′} ) , {z}^{*} - z )\end{matrix} \qquad Equation 2$$

Here, (x*, y*) represents x and y components of the target capture point, CP is the target capture point, z* is the target hip height, and z is the current hip height.

The compensation force (f) using the position error (e) of triaxial coordinates is calculated by Equation 3 below.

f=kₚe Equation 3

Here, kₚ is force gain, and Proportional (P) control is used.

The distribution unit 254 distributes the compensation forces to the two legs 160R and 160L.

The distribution unit 254 distributes a large amount of the compensation force to a leg closer to the point of the COG of the robot 100 projected onto the surface ground using a distance ratio between the projected point of the COG and the two feet 170R and 170L of the robot 100.

The torque calculation unit 255 calculates torques to be transmitted to the respective joint units 163, 164 and 165 based on force compensation and moment compensation. Here, the torques are rotary forces of the motors (not shown) to track target angles.

At this time, the torque calculation unit 255 calculates torques to be applied to the two legs based on the forces distributed by the distribution unit 254.

Further, the torque calculation unit 255 may use gravity compensation. This will be described in more detail.

The torque calculation unit 255 includes a virtual gravity setup unit 255a, a gravity compensation torque calculation unit 255b and a target torque calculation unit 256c.

The virtual gravity setup unit 255a sets intensities of virtual gravity necessary for the respective joints units 163, 164 and 165 of the robot 100 using the current state of the FSM stored in advance and the intensities of the compensation forces calculated by the compensation force calculation unit 253a, and the virtual gravity set using the compensation force is calculated by Equation 4 below.

g_{f}=f/m Equation 4

Here, g_{f} is virtual gravity, f is compensation force calculated by the compensation force calculation unit 253a, and m is mass of the robot 100.

The gravity compensation torque calculation unit 255b calculates gravity compensation torques necessary for the respective joint units 163, 164 and 165 to compensate for the virtual gravity set by the virtual gravity setup unit 255a and actual gravity, and the gravity compensation torques may be calculated using the sum of virtual acceleration of gravity and actual acceleration of gravity, the angles of the respective joint units, the weights of the respective links, and the positions of the COGs in the respective links.

Further, the gravity compensation torque calculation unit 255b calculates the gravity compensation torques necessary for the respective joint units 163, 164 and 165 of the respective legs 160R and 160L in consideration of compensation forces distributed to the two legs 160R and 160L.

The target torque calculation unit 256c calculates target torques necessary for the respective joint units 163, 164 and 165 of the robot 100 by summing the gravity compensation torques calculated by the gravity compensation torque calculation unit 255b and torques corresponding to the compensation moments calculated by the compensation moment calculation unit 253b.

Here, the target torque calculation unit 256c calculates target torques to generate compensation forces of the respective joints unit 163, 164 and 165 of the right and left legs 160R and 160L in consideration of the compensation forces distributed to the two legs 160R and 160L.

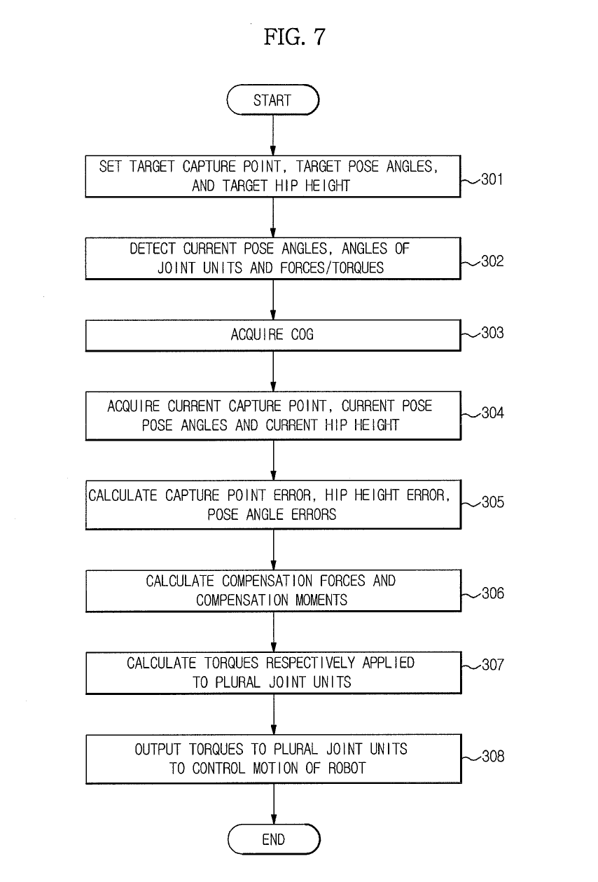

FIG. 7 is a flowchart illustrating a balance control method of the robot in accordance with an embodiment.

The robot 100 drives the plural motors (not shown) installed at the respective joint units 131, 143, 144, 163, 164 and 165 based on a user command received through the input unit 270 and a pose of the robot 100, thus performing a motion.

During performing dancing or walking based on motion data received from a user, the robot 100 judges a current pose based on the angles of the plural joint units and the pose angles of the upper body, judges a next pose by comparing the current pose with the motion data received through the input unit 270, and sets a target capture point, target pose angles and a target hip height to perform the next pose (Operation 301).

Further, during walking based on the FSM, the robot may judge a current walking state based on the states of the FSM which are stored in advance, and set the target capture point, the target pose angles and the target hip height based on the judged current walking state.

At this time, the robot 100 detects the positions and directions of the two feet 170R and 170L using forces/torques applied to the two legs 160R and 160L, judges the current walking state based on the positions of the two feet 170R and 170L and the states of the FSM stored in advance, and sets the target capture point, the target pose angles and the target hip height based on the judged current walking state.

The robot 100 calculates an error between the current pose and the next pose, i.e., a target pose, and performs the next pose while keeping balance by compensating for the calculated error. Hereinafter, this will be described in more detail.

The robot 100 detects forces/torques applied to the two legs 160R and 160L, the pose angles of the upper body and the angles of the plural joint units 131, 143, 144, 163, 164 and 165 through the force/torque detection unit 210, the pose detection unit 220 and the angle detection unit 230 (Operation 302).

Thereafter, the robot 100 acquires the COG of the robot 100 based on the pose angles of the upper body, the angles of the respective joint units 131, 143, 144, 163, 164 and 165 and the positions and directions of the feet 170R and 170L detected through the force/torque detection unit 210, the pose detection unit 220 and the angle detection unit 230 (Operation 303).

Thereafter, the robot 100 acquires a current capture point based on the COG, acquires a current chip height based on the pose angles and the angles of the plural respective units 131, 143, 144, 163, 164 and 165, and acquires the pose angles in three axis directions, i.e., yaw, roll and pitch directions, detected by the pose detection unit 220 (Operation 304).

Here, forward kinematics is used to acquire the position and velocity of the current COG of the robot 100 and the hip height.

The compensation force of the robot 100 is calculated by Equation 1 below using the position and velocity of the COG.

CP=dCOG+w*vCOG Equation 1

Here, CP is a capture point, dCOG the position of a point of the COG projected onto the ground surface, and vCOG is the velocity of the projected point of the COG.

Further, w is √(I/g), I is the height from the ground surface to the COG, and g is acceleration of gravity.

Thereafter, the robot 100 calculates a capture point error by comparing the current capture point with the target capture point, calculates a hip height error by comparing the current hip height with the target hip height, and calculates pose angle errors by comparing the current pose angles with the target pose angles (Operation 305).

Thereafter, the robot 100 acquires x-axis and y-axis coordinate values in the horizontal direction from the capture point error, and calculates compensation forces in the x and y directions.

Further, the robot 100 acquires a z-axis coordinate value in the vertical direction from the hip height error, and calculates compensation force in the z direction.

The compensation force is calculated by Equation 1 below.

CP=dCOG+w*vCOG Equation 1

Since a set of coordinates of the horizontal components of the COG is (x, y) and the velocity of the COG is (x′, y′) obtained by differentiating the set of coordinates of the horizontal components, a relation expression of CP=(x, y)+w(x′, y′)=(x+wx', y+wy') is satisfied.

A position error (e) of triaxial coordinates in which the capture point and the hip height are reflected is calculated by Equation 2 below.

### Equation 2

$$\begin{matrix}e = ( [ ( {x}^{*} , {y}^{*} ) - ( x + {wx}^{′} , y + {wy}^{′} ) ] , {z}^{*} - z ) \\ = ( {x}^{*} - ( x + {wx}^{′} ) , {y}^{*} - ( y + {wy}^{′} ) , {z}^{*} - z )\end{matrix}$$

Here, (x*, y*) represents x and y components of the target capture point, CP is the target capture point, z* is the target hip height, and z is the current hip height.

The compensation force (f) using the position error (e) of triaxial coordinates is calculated by Equation 3 below.

f=kₚe [Equation 3]

Here, kₚ is force gain, and Proportional (P) control is used.

Thereafter, the robot 100 distributes a large amount of the compensation forces to a leg closer to the point of the COG of the robot 100 projected onto the surface ground using a distance ratio between the projected point of the COG and the two feet 170R and 170L of the robot 100.

Thereafter, the robot 100 sets intensities of virtual gravity necessary for the respective joints units 163, 164 and 165 of the robot 100 using the current state of the FSM stored in advance and the intensities of the compensation forces calculated by the compensation force calculation unit 253a.

The virtual gravity set using the compensation force is calculated by Equation 4 below.

g_{f}=f/m Equation 4

Here, g_{f} is virtual gravity, f is compensation force calculated by the compensation force calculation unit 253a, and m is mass of the robot 100.

Thereafter, the robot 100 calculates compensation moments in the yaw, roll and pitch directions based on the pose angle errors (Operation 306).

Since there is no order to calculation of the compensation forces and calculation of the compensation moments, calculation of the compensation forces and calculation of the compensation moments may be reversed.

Thereafter, the robot 100 calculates gravity compensation torques necessary for the respective joint units 163, 164 and 165 to compensate for the virtual gravity and actual gravity, and the gravity compensation torques are calculated using the sum of virtual acceleration of gravity and actual acceleration of gravity, the angles of the respective joint units, the weights of the respective links, and the positions of the COGs in the respective links.

Here, the gravity compensation torques necessary for the respective joint units 163, 164 and 165 of the respective legs 160R and 160L are calculated in consideration of compensation forces distributed to the two legs 160R and 160L.

Thereafter, the robot 100 calculates target torques necessary for the respective joint units 163, 164 and 165 of the robot 100 by summing the gravity compensation torques and torques corresponding to the compensation moments (Operation 307).

Here, the target torques to generate compensation forces of the respective joints unit 163, 164 and 165 of the right and left legs 160R and 160L are calculated in consideration of the compensation forces distributed to the two legs 160R and 160L.

Thereafter, the robot 100 outputs the calculated target torques to the respective joints 163, 164 and 165 of the right and left legs 160R and 160L, thus performing a balanced motion (Operation 308).

Thereby, the robot 100 may keep balance during performance of the motion, thus flexibly and stably performing the motion.

As is apparent from the above description, in a balance control apparatus of a robot and a control method thereof in accordance with an embodiment, torques of plural joint units to keep balance of the robot in the next pose are acquired using a capture point obtained by combining the position and velocity of the COG of the robot, thereby enabling the robot to keep balance in environments having many disturbances.

Further, since a pose of the upper body of the robot is controlled, the robot may stably keep balance without falling on an inclined plane or an uneven plane, thus actively coping with an external disturbance.

Moreover, the robot may walk without bending knees, thus being capable of walking with long strides and effectively using energy necessary for walking.

The embodiments can be implemented in computing hardware and/or software, such as (in a non-limiting example) any computer that can store, retrieve, process and/or output data and/or communicate with other computers. For example, the balance controller 250 in FIG. 3 may include a computer to perform operations and/or calculations described herein. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A balance control method of a robot, which has a plurality of legs, each leg having a plurality of joint units, and an upper body connected to the plurality of legs, comprising:
detecting pose angles of the upper body and angles of the plurality of joint units of each leg;
acquiring a current capture point and a current hip height based on the detected pose angles and the detected angles of the plurality of joint units of each leg;
calculating a capture point error by comparing the acquired current capture point with a predetermined target capture point;
calculating a hip height error by comparing the acquired current hip height with a predetermined target hip height;
calculating, by a computer, compensation forces based on the calculated capture point error and the calculated hip height error;
calculating, by a computer, torques respectively to be applied to the plurality of joint units based on the calculated compensation forces; and
outputting the calculated torques to the plurality of joint units so that the calculated torques are applied to the plurality of joint units to control balance of the robot.

2. The balance control method according to claim 1, wherein acquisition of the current capture point includes:
acquiring a center of gravity (COG) of the robot based on the detected pose angles of the upper body and the detected angles of the plurality of joint units;
acquiring a position and velocity of a point of the acquired COG projected onto a ground surface; and
acquiring the current capture point based on the acquired position and velocity of the point of the acquired COG projected onto the ground surface.

3. The balance control method according to claim 2, wherein calculation of the current hip height includes calculating the current hip height based on the acquired COG and the detected angles of the plurality of joint units.

4. The balance control method according to claim 1, wherein calculation of the compensation forces includes:
calculating compensation forces in a horizontal direction using the calculated capture point error; and
calculating compensation force in a vertical direction using the calculated hip height error.

5. The balance control method according to claim 1, further comprising:
judging a current pose based on the detected pose angles of the upper body and the detected angles of the plurality of joint units; and
setting the target capture point and the target hip height based on the judged current pose and motion data stored in advance.

6. The balance control method according to claim 1, wherein calculation of the torques includes:
calculating a distance ratio between a point of a COG of the robot projected onto a ground surface and feet connected to the plurality of legs;
distributing the calculated compensation forces so that the calculated calculation forces are applied to the plurality of legs based on the calculated distance ratio; and
calculating the torques based on the distributed, calculated compensation forces.

7. The balance control method according to claim 1, wherein acquisition of the current capture point comprises:
using forward kinematics to acquire the current capture point.

8. The balance control method according to claim 1, further comprising:
calculating pose angle errors by comparing current pose angles of the upper body with predetermined target pose angles;
calculating compensation moments based on the calculated pose angle errors; and
calculating the torques respectively applied to the plurality of joint units based on the calculated compensation moments.

9. The balance control method according to claim 8, wherein calculation of the compensation moments includes calculating compensation moments in the yaw, roll and pitch directions using the calculated pose angle errors.

10. A balance control apparatus of a robot, which has a plurality of legs, each leg having a plurality of joint units, and an upper body connected to the plurality of legs, comprising:
a pose detection unit to detect pose angles of the upper body;
an angle detection unit to detect angles of the plurality of joint units of each leg;
a setup unit to set a target capture point and a target hip height based on motion data stored in advance;
a balance controller to acquire a current capture point and a current hip height based on the detected pose angles and the detected angles of the plurality of joint units of each leg, to calculate a capture point error by comparing the acquired current capture point with the set target capture point, to calculate a hip height error by comparing the acquired current hip height with the set target hip height, to calculate compensation forces based on the calculated capture point error and the calculated hip height error, and to calculate torques respectively to be applied to the plurality of joint units based on the calculated compensation forces; and
a servo controller to respectively output the calculated torques to the plurality of joint units so that the calculated torques are applied to the plurality of joint units.

11. The balance control apparatus according to claim 10, wherein the balance controller includes an acquisition unit to acquire a center of gravity (COG) of the robot based on the detected pose angles of the upper body and the detected angles of the plurality of joint units of each leg and to acquire the current capture point and the hip height based on the acquired COG.

12. The balance control apparatus according to claim 10, wherein the balance controller calculates compensation forces in a horizontal direction using the calculated capture point error, and calculates compensation force in a vertical direction using the calculated hip height error.

13. The balance control apparatus according to claim 10, further comprising a force/torque detection unit to detect loads respectively applied to feet provided on the plurality of legs,
wherein the setup unit judges a current pose based on the detected loads, and sets the target capture point and the target hip height based on a current pose and the motion data stored in advance.

14. The balance control apparatus according to claim 10, further comprising a distribution unit to calculate a distance ratio between a point of a COG of the robot projected onto a ground surface and feet connected to the plurality of legs and to distribute the calculated compensation forces so that the calculated compensation forces are applied to the plurality of legs based on the calculated distance ratio,
wherein the balance controller calculates the torques based on the distributed, calculated compensation forces.

15. The balance control apparatus according to claim 10, wherein the balance controller calculates pose angle errors by comparing current pose angles of the upper body with predetermined target pose angles, calculates compensation moments based on the calculated pose angle errors, and reflects the calculated compensation moments in calculation of the torques.

16. The balance control apparatus according to claim 15, wherein the balance controller calculates compensation moments in the yaw, roll and pitch directions using the calculated pose angle errors.

17. The balance control apparatus according to claim 10, wherein the setup unit sets one point located within a support region of feet provided on the plurality of legs as the target capture point.

18. The balance control apparatus according to claim 10, further comprising an input unit to receive motion data including at least one pose from a user,
wherein the setup unit stores the received motion data.
